(19) United States
(12) Patent Application Publication
(10) Pub. No.: US 2002/0138942 A1
(43) Pub. Date: Oct. 3, 2002

(54) Grommet

(76) Inventors: Hidetoshi Sato, Shizuoka (JP); Keiichiro Soma, Tokyo (JP)

Correspondence Address: Sughrue, Mion, Zinn Macpeak & Seas, PLLC, 2100 Pennsylvania Avenue, N.W., Washington, DC, 20037, US

(21) Appl. No.: 09/453,898

(22) Filed: Mar. 27, 2000

(30) Foreign Application Priority Data
Mar. 31, 1999 (JP) P. HEI 11-093492

(51) Int. Cl. H02G 3/22

(52) U.S. Cl. 16/2.1

(57) ABSTRACT

At a flange portion 6 of a grommet body 2, is formed a panel engaging member 7 which is adapted to engage with a hole edge 12 of a panel 10. The flange portion 6 adjacent to the panel engaging member 7 is grasped between a retainer 20 and the panel 10, and rigidly fastened by means of bolts and nuts.

### CROSS-REFERENCE TO RELATED APPLICATIONS

Not Applicable

### STATEMENT REGARDING FEDERALLY SPONSORED RESEARCH

Not Applicable

### REFERENCE TO A MICROFICHE APPENDIX

Not Applicable

### BACKGROUND OF THE INVENTION

2. Description of Related Art

A related grommet as shown in FIGS. 8 to 10 has been known as the grommet of this type. This grommet 60 includes a grommet body 62 in a shape of a funnel which is fixed to a panel 75 by screws, employing a retainer 70, bolts 80 and nuts 81 in a state where the grommet body 62 is pressed onto a panel 75. A method of fitting the grommet 60 will be described hereunder.

As shown in FIGS. 8 and 9, the grommet 60 is applied to a determined position on the panel 75 in a state where the grommet 60 is pushed by a force in a direction of an arrow F so as to press a lip 64 which is formed at a flange portion 63 of the grommet body 62.

Then, as shown in FIG. 10, the retainer 70 is disposed at a predetermined position on the panel 75 in a state where the retainer 70 is inserted into an engagement groove 66 which is formed at the flange portion 63 of the grommet body 62. Then the retainer 70 is rigidly fastened to the panel 75 by passing the bolts 80 through holes respectively formed in the retainer 70 and the panel 75 and by employing the nuts 81. With this arrangement, the grommet 60 is fitted to the panel 75 with the flange portion 63 of the grommet body 62 grasped.

The grommet 60 as constructed in this way is prevented from an accidental disengagement from the panel by vibration, etc. and is highly reliable as compared with the grommet which is simply inserted in the fitting hole of the panel.

However, with the above described grommet 60 to be fixed by bolting, the grommet body 62 must be fixed to the panel 75 by means of the bolts 80 and the nuts 81, after the retainer 70 has been positioned on the panel 75 to be held on the panel, while the grommet body 62 is pressed to the panel 75. Therefore, the fitting workability of the grommet 60 has been bad and the working efficiency has been deteriorated. In particular, in a relatively narrow working space such as in an automobile or the like, the fitting work has been far more difficult.

In addition, because a waterproof property has been ensured with such a structure that the lip 64 of the grommet 60 is simply pressed to the panel 75, there has been a drawback that sealing property is decreased when the panel 75 has undulations on its surface, and a desired waterproof effect cannot be obtained.

2. Field of the Invention

This invention relates to a grommet through which a wire harness or the like is adapted to pass to be held and which can prevent water, etc. from intruding through a gap between a fitting hole in a panel or the like which is an object to be fitted, and more particularly to such a grommet which has an improved fitting workability to the panel or the like.

### SUMMARY OF THE INVENTION

The invention has been made in view of the above described circumstances, and it is an object of the invention to provide a grommet which is improved in the fitting workability to an object to be fitted and can obtain an excellent reliability in the waterproof property.

In order to achieve the above described object, according to the invention, there is provided, a grommet fitted with a fitting hole formed in a support body through which a wire harness is inserted, comprising:

a cylindrical main body one end portion of which is to be inserted into the fitting hole such that the wire harness is passed through the main body;

a flange portion formed on outer periphery of the main body and positioned an outer peripheral portion of the fitting hole;

an elastic engagement member integrally formed with the flange portion for holding the circumferential edge of the fitting hole;

a retainer for fastening the flange portion together with the support body; and

a fixing member for fixing the retainer to the support body.

Preferably, the end portion of the main body which is to be inserted into the fitting hole is tapered, and a groove is formed at an end of the tapered portion. The circumferential edge of the fitting hole is fitted with the groove such that the tapered portion and the groove serve as the engagement member.

According to the invention, the grommet can be provisionally secured to the support body by engaging the circumferential edge of the fitting hole which is opened in the support body into the engagement member which is formed at the flange portion of the grommet body. Accordingly, on occasion that a retainer is employed in the next step of the work to be fastened by the fixing member, the fitting work can be conducted without a necessity of holding the grommet.

Moreover, because the circumferential edge of the fitting hole is engaged into the engagement member which is formed in a shape of a groove, the sealing property can be enhanced by means of a pressing force of lips which are formed at the flange portion of the grommet body and applied to the support body.

### BRIEF DESCRIPTION OF THE DRAWINGS

In the accompanying drawings:

FIG. 1 is a partially-sectional perspective view showing a first embodiment of a grommet according to the invention;

FIG. 2 is a sectional view showing a manner of fitting the grommet of FIG. 1;

FIG. 3 is an enlarged view of a part A in FIG. 2 which is an enlarged view of an essential part of the grommet;

FIG. 4 is a sectional view of the grommet of FIG. 1 in a state where the grommet is fitted to a panel;

FIG. 5 is a sectional view showing a manner of fitting a grommet according to a second embodiment of the invention;

FIG. 6 is an enlarged view of a part B in FIG. 5 which is an enlarged view of an essential part of the grommet;

FIG. 7 is a sectional view of the grommet in FIG. 5 in a state where the grommet is fitted to a panel;

FIG. 8 is a sectional view showing a manner of fitting a related grommet;

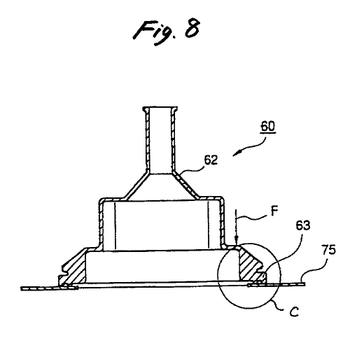

FIG. 9 is an enlarged view of a part C in FIG. 8; and

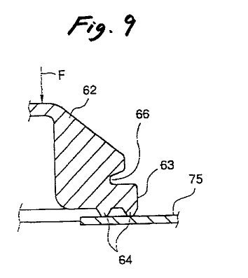

FIG. 10 is a sectional view illustrating a manner of fitting the grommet of FIG. 8.

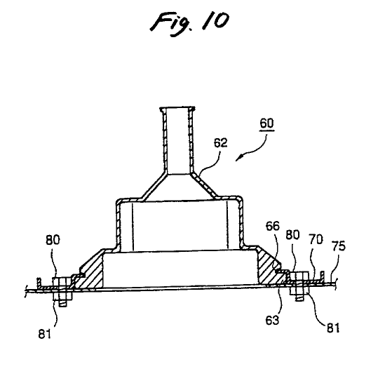

### DETAILED DESCRIPTION OF THE PREFERRED EMBODIMENTS

Preferred embodiments of the grommet according to the invention will be described in detail hereunder referring to the drawings.

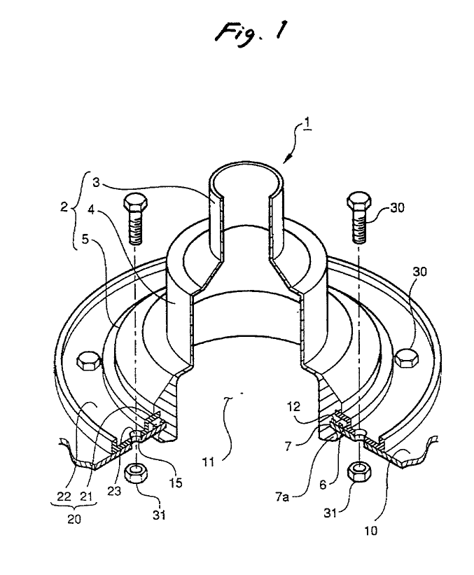

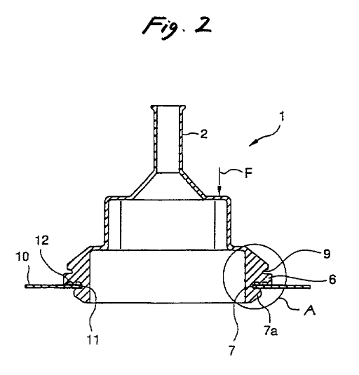

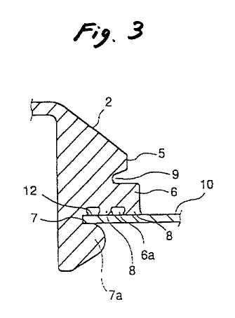

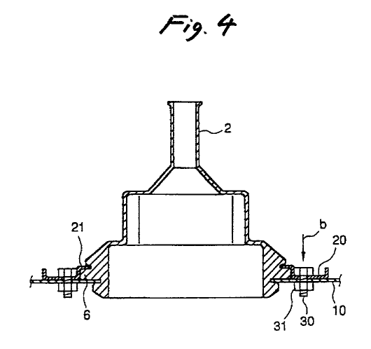

FIG. 1 is a partially-sectional perspective view showing a first embodiment of the grommet according to the invention, FIG. 2 is a sectional view illustrating a manner of fitting the grommet, FIG. 3 is an enlarged view of a part A in FIG. 2 which is an enlarged view of an essential part of the grommet according to the invention, and FIG. 4 is a sectional view of the grommet in a state where the grommet is fitted to a panel.

As shown in FIG. 1, a grommet 1 comprises a grommet body 2 which is formed of a resin substantially in a shape of a funnel and adapted to receive a wire harness which is not shown to pass therethrough for protection thereof. The grommet body 2 is fitted to a panel 10 which is an object to be fitted, by means of a retainer 20, bolts 30 and nuts 31.

Describing in more detail, the grommet body 2 has a small cylindrical part 3 into which the not shown wire harness is inserted, a medium cylindrical part 4 which is larger in diameter than the small cylindrical part 3, and a large cylindrical part 5 which is further larger in diameter than the medium cylindrical part 4.

The large cylindrical part 5 is provided with a flange portion 6 which is adapted to be pressed onto the panel 10 as shown in FIG. 3, and a plurality of annular lips 8 formed on a panel pressing face 6a. The flange portion 6 adjacent to the panel pressing face 6a is annularly formed with an engagement groove 9 into which an end of the retainer 20 is inserted.

Further, the grommet body 2 is provided at the flange portion 6 with an engaging member for the object to be fitted (panel engaging member) 7 which can provisionally secure the grommet body 2 to the panel 10 by inserting therein a circumferential edge (hole edge) 12 of a fitting hole 11 which is formed in the panel 10. At the circumferential part 6 adjacent to the panel engaging member 7, there is further provided a projection 7a which is adapted to abut against the panel face by resilient return force, after the hole edge 12 of the fitting hole 11 has passed it through.

The retainer 20 is an annular body including an inner circumferential part 21 adapted to be inserted into the engagement groove 9 of the grommet body 2, and a flange portion 22 formed around the inner circumferential part 21 with a stepped difference. The retainer 20 is fixed to the panel 10 in a state where holes 23 formed in the flange portion 22 are positioned with holes 15 formed in the panel 10, by passing bolts 30 therethrough and fastening by means of nuts 31.

Referring now to FIGS. 2 to 4, the manner in which the grommet 1 is fitted will be described.

As shown in FIG. 2, by pushing the grommet body 2 in a direction of an arrow F and inserting it into the fitting hole 11 in the panel 10, the hole edge 12 of the panel 10 rides over the projection 7a of the grommet body 2 to enter in the panel engaging member 7. In this manner, the grommet 1 is provisionally secured to the panel 10.

In this provisionally secured state, the lips 8 formed on the panel pressing face 6a press the panel 10 and come into a compressed state as shown in FIG. 3. In other words, on occasion that the grommet 1 has been provisionally secured to the panel 10, water intruding from the exterior of the grommet body 2 can be sealed by an action of the force pressed by the lips 8 and the hole edge 12 which has been inserted into the engaging member 7.

Then, in a state where the inner circumferential edge 21 of the retainer 20 is inserted in the engagement groove 9 of the grommet body 2, the holes 23 formed in the retainer 20 and the holes 15 in the panel 10 (both are shown in FIG. 1) are aligned with each other. After the bolts 30 have been inserted in a direction of an arrow b so as to pass the respective holes 23 and 15, the retainer 20 is rigidly fastened to the panel 10 by means of the nuts 31. In this manner, the grommet body 2 is fixed to the panel 10 with its circumferential part 6 pressed and grasped by the retainer 20 and the panel 10. On this occasion, the lips 8 will be further compressed to increase the sealing property.

According to the above described embodiment, by provisionally securing the grommet 1 with the engagement of the hole edge 12 in the panel engaging member 7, the retainer 20 can be fitted to the panel 10 by bolting, without a necessity of such a connecting work that the grommet body 2 is held and positioned onto the panel 10 which has been required with the related grommet. Accordingly, fitting of the grommet 1 to the panel 10 will be facilitated, and the fitting workability can be enhanced.

Moreover, owing to the compression of the lips 8 generated prior to the fitting of the retainer 20, the engagement of the panel 10 into the panel engaging member 7, and the pressing action by the retainer 20, the sealing property will be increased to improve the waterproof property.

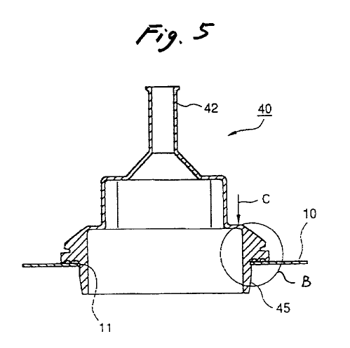

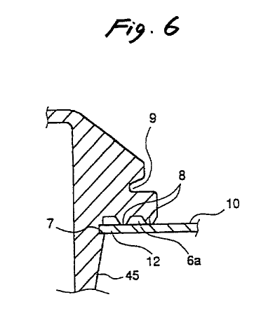

Now, a second embodiment of the grommet according to the invention will be described referring to FIGS. 5 to 7. The same members and the same parts as in the first embodiment will be denoted with the same reference numerals and signs, and a further explanation will be omitted.

In this embodiment, a tapered part 45 is formed at a distal end of the grommet body 42 in a direction of insertion into the panel, in place of the projection 7a (refer to FIG. 3) in the first embodiment.

When the tapered part 45 of the grommet body 42 as thus constructed is inserted into the fitting hole 11 in the panel 10 in a direction of an arrow c in FIG. 5 so as to press the grommet body 42, the hole edge 12 of the panel 10 is engaged with the base portion 7 of the tapered part 45 in such a manner that the base portion 7 is resiliently pressed in radially inward direction. In short, the base portion 7 of the tapered part 45 acts as an engaging member for the object to be fitted. Then, the grommet body 42 is provisionally secured to the panel 10 in a state where the lips 8 formed on the panel pressing face 6a press the hole edge 12 of the panel 10.

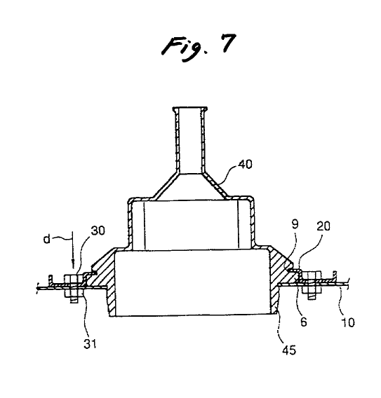

Then, as shown in FIG. 7, the retainer 20 is positioned in engagement with the engagement groove 9 of the grommet body 42, and inserting the bolts 30 in a direction of an arrow d, the retainer 20 is rigidly fastened to the panel 10 by means of the nuts 31.

With this operation, the grommet 40 can be fixed to the panel 10 in a state where the flange portion 6 of the grommet body 42 is grasped between the retainer 20 and the panel 10. On this occasion, the lips 8 are brought into the compressed state.

In this embodiment, because the tapered part 45 is formed at the distal end of the grommet body 42, insertion of the grommet 40 into the fitting hole 11 can be conducted easily, and the workability will be enhanced. Further, similarly to the first embodiment, the grommet body 42 can be provisionally secured to the panel 10 by engaging the hole edge 12 of the panel 10 with the base portion 7, and the workability will be improved. Moreover, the sealing property can be increased to enhance the waterproof property, by the compressed state of the lip 8 and the engagement of the hole edge 12 with the panel engaging member 7.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A grommet fitted with a fitting hole formed in a support body through which a wire harness is inserted, comprising:
a cylindrical main body one end portion of which is to be inserted into the fitting hole such that the wire harness is passed through the main body;
a flange portion formed on outer periphery of the main body and positioned an outer peripheral portion of the fitting hole;
an elastic engagement member integrally formed with the flange portion for holding the circumferential edge of the fitting hole;
a retainer for fastening the flange portion together with the support body; and
a fixing member for fixing the retainer to the support body.

2. The grommet as set forth in claim 1,
wherein the end portion of the main body which is to be inserted into the fitting hole is tapered, and a groove is formed at an end of the tapered portion; and
wherein the circumferential edge of the fitting hole is fitted with the groove such that the tapered portion and the groove serve as the engagement member.
